(19) United States
(12) Patent Application Publication
(10) Pub. No.: US 2024/0428581 A1
(43) Pub. Date: Dec. 26, 2024

(54) HOUSE STATUS PROVISION APPARATUS AND HOUSE STATUS PROVISION METHOD

(71) Applicant: FUJIFILM Corporation, Tokyo (JP)

(72) Inventor: Shinji HAYASHI, Tokyo (JP)

(73) Assignee: FUJIFILM Corporation, Tokyo (JP)

(21) Appl. No.: 18/822,828

(22) Filed: Sep. 3, 2024

Related U.S. Application Data
(63) Continuation of application No. PCT/JP2023/005725, filed on Feb. 17, 2023.

(30) Foreign Application Priority Data
Mar. 4, 2022 (JP) 2022-033524

(51) Int. Cl. G06V 20/10; G06V 10/50; G06V 10/70; G06V 10/75; G06V 10/764; G06V 20/17; G06V 20/50

(52) U.S. Cl. CPC G06V 20/176; G06V 10/50; G06V 10/751; G06V 10/764; G06V 10/87; G06V 20/17; G06V 20/50

(57) ABSTRACT

An aerially captured image of a disaster region is matched with a map stored in a database. External shape information of a house on the aerially captured image is acquired from a result of matching processing and from region information of the house included in the map, and a house image showing the house is extracted from the aerially captured image based on the external shape information of the house. Disaster status of each house is recognized based on the extracted house image. The house is classified as any of a plurality of classes of intactness, partial collapse, and complete collapse using a recognition result. The house on the aerially captured image is associated with the classified class. The aerially captured image is combined with information indicating a classification result and is displayed on an image display device.

### CROSS-REFERENCE TO RELATED APPLICATIONS

The present application is a Continuation of PCT International Application No. PCT/JP2023/005725 filed on Feb. 17, 2023 claiming priority under 35 U.S.C § 119(a) to Japanese Patent Application No. 2022-033524 filed on Mar. 4, 2022. Each of the above applications is hereby expressly incorporated by reference, in its entirety, into the present application.

### BACKGROUND OF THE INVENTION

### 1. Field of the Invention

The present invention relates to a house status provision apparatus and a house status provision method, and particularly to a technology for recognizing status of each house captured in an aerially captured image captured at a time of occurrence of a disaster and providing a recognition result in an understandable manner.

### 2. Description of the Related Art

In the related art, a technology for determining status such as partial collapse/complete collapse of each house (structure) captured in an aerially captured image based on the aerially captured image captured at a time of occurrence of a disaster has been suggested (WO2013/051300A).

The disaster status perception system according to WO2013/051300A three-dimensionally captures a ground image of a target area at the time of occurrence of the disaster using a three-dimensional imaging camera mounted on a flying object and acquires imaging condition information including three-dimensional positional coordinates of the flying object in capturing the three-dimensional ground image. A feature point is extracted from the three-dimensional ground image, and three-dimensional coordinates of the extracted feature point are acquired based on the three-dimensional ground image and the imaging condition information.

Meanwhile, the disaster status perception system stores a three-dimensional ground image captured (at a normal time) before the disaster occurs and three-dimensional coordinates of a feature point extracted from the three-dimensional ground image in a normal time storage device, and performs disaster analysis on the three-dimensional ground images before and after the disaster occurs by three-dimensionally comparing the three-dimensional coordinates of the feature point extracted at the time of occurrence of the disaster with the three-dimensional coordinates of the feature point at the normal time and detecting a feature point of a part deformed after the disaster occurs.

In addition, the disaster status perception system includes a database storing region information and related information (a place name, a road name, a building name, an address, a map code, and the like) of a structure present in the target area, specifies a structure subjected to the disaster by comparing three-dimensional coordinates of the feature point of the deformed part with the region information stored in the database, and acquires the related information of the structure subjected to the disaster from the database.

The related information of the structure subjected to the disaster and disaster status (a marker of partial collapse/complete collapse) are displayed in a superimposed manner on a map or the three-dimensional ground image of the target area.

### SUMMARY OF THE INVENTION

The disaster status perception system according to WO2013/051300A performs the disaster analysis on the three-dimensional ground images before and after the disaster occurs by three-dimensionally comparing the three-dimensional coordinates of the feature point extracted at the time of occurrence of the disaster with the three-dimensional coordinates of the feature point at the normal time stored in the normal time storage device and detecting the feature point of the part deformed after the disaster occurs. However, it is generally difficult to accurately extract a feature point from a captured image. Particularly, it is not easy to accurately extract a plurality of feature points for each building captured in an aerially captured three-dimensional ground image. In addition, it is still more difficult to obtain a correspondence relationship between the feature point extracted from the three-dimensional ground image captured at the time of occurrence of the disaster and the feature point extracted from the three-dimensional ground image that is captured at the normal time and that is stored in the normal time storage device, and it is considered that the disaster analysis cannot be favorably performed.

In addition, the three-dimensional ground image captured at the normal time may be different from a three-dimensional ground image immediately before the occurrence of the disaster because of new construction, reconstruction, extension and improvement, and the like of houses. Meanwhile, an issue arises in that it is cumbersome to update the three-dimensional ground image and the three-dimensional coordinates of the feature point stored in the normal time storage device with the most recent data at all times.

The present invention has been conceived in view of such circumstances, and an object of the present invention is to provide a house status provision apparatus and a house status provision method that can favorably recognize status of each house in a region in which a disaster has occurred and associate a recognition result with each house on an aerially captured image.

In order to achieve the object, the invention according to a first aspect provides a house status provision apparatus comprising a processor, in which the processor is configured to perform processing of acquiring an aerially captured image in which a target region in which a plurality of houses are present is imaged, matching processing of matching a map stored in a memory to the aerially captured image based on the aerially captured image and on the map, processing of acquiring external shape information of the house on the aerially captured image from a result of the matching processing and from region information of the house included in the map, processing of extracting a house image showing the house from the aerially captured image based on the acquired external shape information of the house, classification processing of recognizing status of each of the plurality of houses based on the extracted house image and classifying the house as any of a plurality of first classes using a recognition result, and processing of associating the house on the aerially captured image with the classified first class.

According to the first aspect of the present invention, the map is matched to the aerially captured image, and the external shape information of the house on the aerially captured image is acquired from the result of the matching processing and from the region information of the house included in the map. The house image showing the house is extracted from the aerially captured image based on the acquired external shape information of the house. The status of each house in a region in which a disaster has occurred can be favorably and quickly recognized based on the extracted house image, and the recognition result can be associated with each house on the aerially captured image.

In the house status provision apparatus according to a second aspect of the present invention, it is preferable that in the first aspect, the memory stores three-dimensional region information of the house included in the map, and the processor is configured to estimate a position and a posture of a camera that captures the aerially captured image, using the matching processing, and acquire the external shape information of the house on the aerially captured image by performing perspective projection transformation of the three-dimensional region information of the house based on the estimated position and the estimated posture of the camera.

In the house status provision apparatus according to a third aspect of the present invention, it is preferable that in the first aspect or the second aspect, the processor is configured to superimpose first information indicating the first class associated with the house on the aerially captured image, on the aerially captured image and display the aerially captured image on a display device. Accordingly, the status of each house on the aerially captured image can be displayed in an understandable manner.

In the house status provision apparatus according to a fourth aspect of the present invention, it is preferable that in the third aspect, the first information is information indicating a frame line that surrounds the house and that has different colors of the frame line or different line types of the frame line depending on the classified first class.

In the house status provision apparatus according to a fifth aspect of the present invention, it is preferable that in any of the first aspect to the fourth aspect, the plurality of first classes are a plurality of first classes including complete collapse and partial collapse corresponding to disaster status of the house caused by a disaster.

In the house status provision apparatus according to a sixth aspect of the present invention, it is preferable that in any of the first aspect to the fifth aspect, the memory stores a learning model that outputs a classification result indicating the first class in a case where the house image is input, and in the classification processing of the processor, the learning model stored in the memory is used, and a classification result estimated by the learning model is acquired by inputting the house image into the learning model.

In the house status provision apparatus according to a seventh aspect of the present invention, it is preferable that in the sixth aspect, the learning model stored in the memory includes a plurality of learning models corresponding to types of disasters, and the processor is configured to select a learning model corresponding to a type of a disaster from the plurality of learning models and acquire the classification result using the selected learning model. Since the status of the house varies depending on the type of the disaster, the status of the house can be more favorably perceived and appropriately classified by selecting and applying the learning model corresponding to the type of the disaster.

In the house status provision apparatus according to an eighth aspect of the present invention, it is preferable that in any of the first aspect to the seventh aspect, the memory stores attribute information related to the house included in the map, and the processor is configured to acquire the attribute information related to the house from the memory and associate the attribute information with the house on the aerially captured image.

In the house status provision apparatus according to a ninth aspect of the present invention, it is preferable that in the eighth aspect, the processor is configured to superimpose first information indicating the first class and the attribute information associated with the house on the aerially captured image, on the aerially captured image and display the aerially captured image on a display device.

In the house status provision apparatus according to a tenth aspect of the present invention, it is preferable that in the eighth aspect, the attribute information related to the house includes the number of years since building of the house or a type of the house, and the processor is configured to classify the number of years since building of the house or the type of the house as any of a plurality of second classes based on the number of years since building of the house or on the type of the house, associate the house on the aerially captured image with the classified second class, and superimpose second information indicating the second class on the aerially captured image and display the aerially captured image on a display device.

The invention according to an eleventh aspect provides a house status provision method executed by a house status provision apparatus including a processor, the method comprising a step of acquiring, via the processor, an aerially captured image in which a target region in which a plurality of houses are present is imaged, a step of performing, via the processor, matching processing of matching a map stored in a memory to the aerially captured image based on the aerially captured image and on the map, a step of acquiring, via the processor, external shape information of the house on the aerially captured image from a result of the matching processing and from region information of the house included in the map, a step of extracting, via the processor, a house image showing the house from the aerially captured image based on the acquired external shape information of the house, a step of recognizing, via the processor, status of each of the plurality of houses based on the extracted house image and classifying the house as any of a plurality of first classes using a recognition result, and a step of associating, via the processor, the house on the aerially captured image with the classified first class.

In the house status provision method according to a twelfth aspect of the present invention, it is preferable that in the eleventh aspect, the memory stores three-dimensional region information of the house included in the map, and the processor is configured to estimate a position and a posture of a camera that captures the aerially captured image, using the matching processing, and acquire the external shape information of the house on the aerially captured image by performing perspective projection transformation of the three-dimensional region information of the house based on the estimated position and the estimated posture of the camera.

In the house status provision method according to a thirteenth aspect of the present invention, it is preferable that in the eleventh aspect or the twelfth aspect, the processor is configured to superimpose first information indicating the first class associated with the house on the aerially captured image, on the aerially captured image and display the aerially captured image on a display device.

In the house status provision method according to a fourteenth aspect of the present invention, it is preferable that in the thirteenth aspect, the first information is information indicating a frame line that surrounds the house and that has different colors of the frame line or different line types of the frame line depending on the classified first class.

In the house status provision method according to a fifteenth aspect of the present invention, it is preferable that in any of the eleventh aspect to the fourteenth aspect, the plurality of first classes are a plurality of first classes including complete collapse and partial collapse corresponding to disaster status of the house caused by a disaster.

According to the present invention, status of each house in a region in which a disaster has occurred can be favorably recognized, and a recognition result can be associated with each house on an aerially captured image.

### BRIEF DESCRIPTION OF THE DRAWINGS

FIG. 1 is a schematic diagram illustrating a configuration example of a system 10 including a house status provision apparatus according to an embodiment of the present invention.

FIG. 2 is a block diagram illustrating an embodiment of a hardware configuration of the house status provision apparatus illustrated in FIG. 1.

FIG. 3 is a functional block diagram illustrating an embodiment of the house status provision apparatus according to the embodiment of the present invention.

FIG. 4 is a diagram illustrating an aerially captured image IM and a map MP corresponding to the aerially captured image IM.

FIG. 5 is a diagram used for describing a position and a posture of a camera.

FIG. 6 is a diagram illustratively illustrating a relationship between a three-dimensional space coordinate system having three axes corresponding to three-dimensional coordinates (x′, y′, z′) based on coordinate transformation in [Expression 1] and an image coordinate system of an image sensor of the camera.

FIG. 7 is a diagram illustrating an example of a composite image in which positions of a house and a road are superimposed on the aerially captured image IM by transforming the map to image coordinates using a camera matrix in which sensor data is used as parameter values.

FIG. 8 is a diagram illustrating an example of a composite image in which the positions of the house and the road are superimposed on the aerially captured image IM by automatically calculating an optimal camera matrix using a matching processing unit and transforming the map MP to image coordinates using the optimal camera matrix.

FIG. 9 is a diagram illustrating a flow in which an external shape information acquisition unit of a house acquires external shape information of the house.

FIG. 10 is a diagram illustrating an example of an aerially captured image combined with first information indicating a classification result of the house.

FIG. 11 is a block diagram illustrating another embodiment of a classification processing unit.

FIG. 12 is a table illustrating a list of attribute information related to the house.

FIG. 13 is a flowchart illustrating an embodiment of a house status provision method according to the embodiment of the present invention.

### DESCRIPTION OF THE PREFERRED EMBODIMENTS

Hereinafter, preferred embodiments of a house status provision apparatus and a house status provision method according to an embodiment of the present invention will be described in accordance with the accompanying drawings.

### [System Including House Status Provision Apparatus]

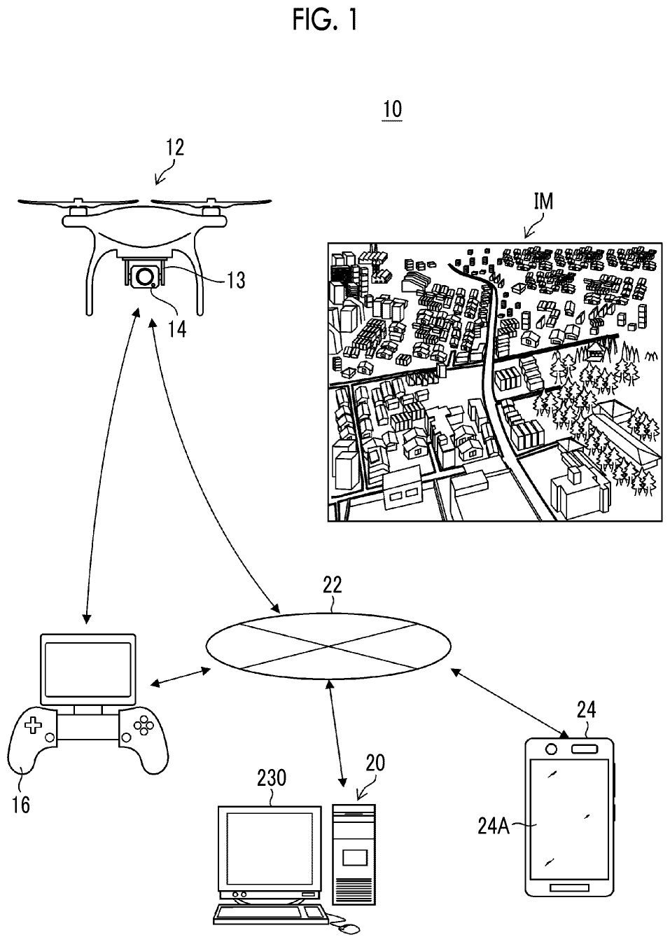

FIG. 1 is a schematic diagram illustrating a configuration example of a system 10 including the house status provision apparatus according to the embodiment of the present invention.

The system 10 is a system for quickly perceiving and providing status of a house in a case where various disasters occur and is installed in, for example, a local government.

The system 10 illustrated in FIG. 1 is configured by connecting a drone 12 for aerial imaging, a remote controller 16, a house status provision apparatus 20, and a terminal apparatus 24 through a network 22.

The drone 12 is an unmanned aerial vehicle that is remotely operated using the remote controller 16.

In a case where a disaster occurs, an investigator who investigates disaster status or a drone operator commissioned by the local government operates the drone 12 using the remote controller 16 and aerially images a target region (disaster region) in which a plurality of houses are present using a camera 14 mounted on the drone 12.

The camera 14 is mounted on the drone 12 through a gimbal head 13. The camera 14 or the drone 12 includes a global positioning system (GPS) receiver, an atmospheric pressure sensor, an azimuth sensor, a gyro sensor, and the like and acquires information indicating a position (latitude, longitude, and altitude) and a posture (an azimuthal angle and a depression angle indicating an imaging direction) of the camera 14 at a time of aerial imaging.

An image (hereinafter, referred to as an “aerially captured image IM”) captured using the camera 14 can be stored in a storage device such as an internal storage incorporated in the camera 14 and/or a memory card detachably mounted on the camera 14. The aerially captured image IM can be transmitted to the remote controller 16 or transmitted to the house status provision apparatus 20 using wireless communication. In addition, the information about the position and the posture of the camera 14 at the time of aerial imaging can be recorded in a header portion of an image file in which the aerially captured image IM is recorded.

The house status provision apparatus 20 is configured using a computer. The computer applied to the house status provision apparatus 20 may be a server, a personal computer, or a workstation.

The house status provision apparatus 20 may perform data communication with the drone 12, the remote controller 16, and the terminal apparatus 24 through the network 22. The network 22 may be a local area network or a wide area network.

The house status provision apparatus 20 can acquire the aerially captured image IM from the drone 12 or the camera 14 through the network 22 or via the remote controller 16. In addition, the house status provision apparatus 20 can acquire the aerially captured image IM from the memory card or the like of the camera 14 without passing through the network 22. This is based on a consideration of a case where a network in a part of the region is disabled by the disaster.

In addition, the house status provision apparatus 20 acquires a required map from an internal memory (database) or from an external database that provides the map. In this case, the map is a map corresponding to the aerially captured image IM and is preferably a map including the location imaged by the aerially captured image IM. Details of the house status provision apparatus 20 and the map and the like will be described later.

The terminal apparatus 24 is, for example, a smartphone or a tablet terminal carried by an officer of the local government, an officer of a fire station, or the like. In addition, the terminal apparatus 24 may have a processing function of the house status provision apparatus 20.

A display device 230 displays the aerially captured image IM or displays various types of information in a superimposed manner on the aerially captured image IM. The terminal apparatus 24 can comprise a display 24A and perform the same display as the display device 230.

### [Hardware Configuration of House Status Provision Apparatus]

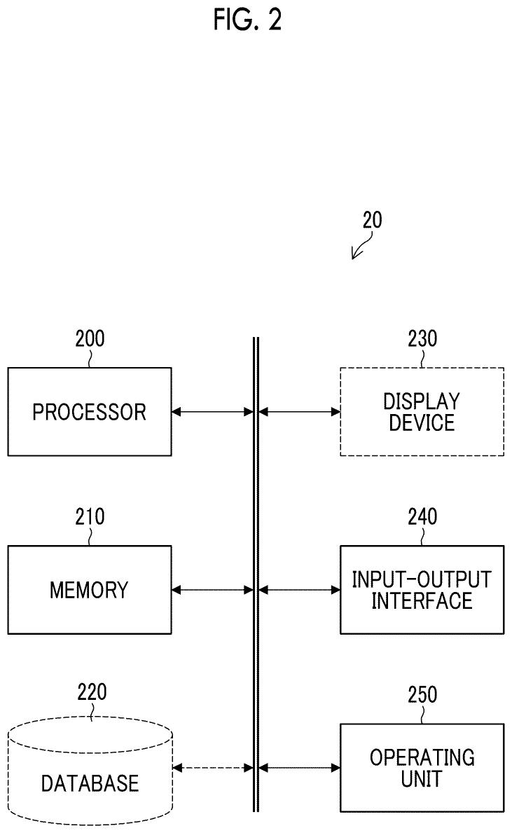

FIG. 2 is a block diagram illustrating an embodiment of a hardware configuration of the house status provision apparatus illustrated in FIG. 1.

The house status provision apparatus 20 illustrated in FIG. 2 comprises a processor 200, a memory 210, a database 220, the display device 230, an input-output interface 240, and an operating unit 250.

The processor 200 is composed of a central processing unit (CPU) or the like, controls each unit of the house status provision apparatus 20 in an integrated manner, and performs matching processing of matching the map to the aerially captured image IM, processing of acquiring external shape information of the house on the aerially captured image IM from a result of the matching processing and from region information of the house included in the map, processing of extracting a house image showing the house from the aerial image IM based on the external shape information of the house, classification processing of recognizing status of each of the plurality of houses based on the house image and classifying the house as any of a plurality of classes (first class) using a recognition result, and the like. Details of the various types of processing of the processor 200 will be described later.

The memory 210 includes a flash memory, a read-only memory (ROM), a random access memory (RAM), and a hard disk apparatus or the like. The flash memory, the ROM, or the hard disk apparatus is a non-volatile memory storing various programs or the like including an operation system. The RAM functions as a work region of the processing performed by the processor 200 and temporarily stores the programs or the like stored in the flash memory or the like. The processor 200 may incorporate a part (RAM) of the memory 210.

In addition, the memory 210 functions as an image storage unit storing the aerially captured image IM and can store and manage the aerially captured image IM.

The database 220 is a part that manages the map of the aerially imaged region. In the present example, the database 220 also manages attribute information of the house related to the house on the map, in addition to the map.

Details of the information managed by the database 220 will be described later. In addition, the database 220 may be configured in the house status provision apparatus 20 or may be an external database connected by communication, for example, a database of Geospatial Information Authority of Japan that manages base map information, or a database of OpenStreetMap.

The display device 230, in accordance with an instruction from the processor 200, displays the aerially captured image IM and displays first information (information classified as the class in accordance with the status of the house) that indicates the first class and that is associated with the house on the aerially captured image IM in a superimposed manner on the aerially captured image IM. In addition, the display device 230 is used as a part of a graphical user interface (GUI) in receiving various types of information from the operating unit 250.

The display device 230 may be included in the house status provision apparatus 20 or may be separately provided outside the house status provision apparatus 20 as illustrated in FIG. 1.

The input-output interface 240 includes a connecting unit connectable to an external apparatus, a communication unit connectable to a network, and the like. A universal serial bus (USB), a high-definition multimedia interface (HDMI) (HDMI is a registered trademark), or the like can be applied as the connecting unit connectable to the external apparatus. The processor 200 can acquire the aerially captured image IM or output required information in accordance with a request from an outside (for example, an external terminal apparatus 24) through the input-output interface 240.

The operating unit 250 includes a pointing device such as a mouse, a keyboard, or the like and functions as a part of the GUI that receives various types of information and instructions input by a user operation.

### [Embodiment of House Status Provision Apparatus]

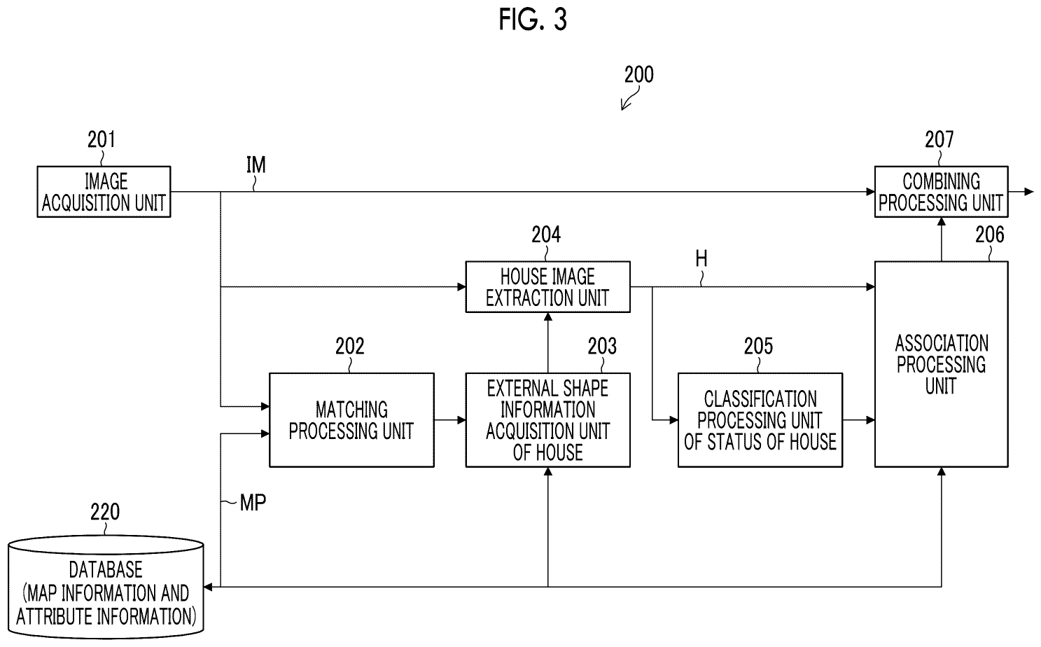

FIG. 3 is a functional block diagram illustrating an embodiment of the house status provision apparatus according to the embodiment of the present invention.

FIG. 3 is a functional block diagram mainly illustrating functions of the processor 200 of the house status provision apparatus 20 illustrated in FIG. 2.

In FIG. 3, the processor 200 functions as a matching processing unit 202, an external shape information acquisition unit 203 of the house, a house image extraction unit 204, a classification processing unit 205 of the status of the house, an association processing unit 206, and a combining processing unit 207.

The image acquisition unit 201 acquires the aerially captured image IM of the disaster region captured by the camera 14 of the drone 12, from the drone 12 through the network 22 or from the memory card of the camera 14.

The aerially captured image IM acquired by the image acquisition unit 201 is output to the matching processing unit 202, the house image extraction unit 204, and the combining processing unit 207.

The matching processing unit 202 performs the processing of matching the map MP to the aerially captured image IM based on the aerially captured image IM and on the map MP stored in the memory (in the present example, the database 220).

Here, the matching processing unit 202 reads out the information indicating the position and the posture of the camera 14 appended to the aerially captured image IM from the header portion of the image file of the aerially captured image IM, predicts the aerially imaged region (block) based on the read information indicating the position and the posture of the camera 14, and acquires the map MP of the region corresponding to the aerially captured image IM from the database 220.

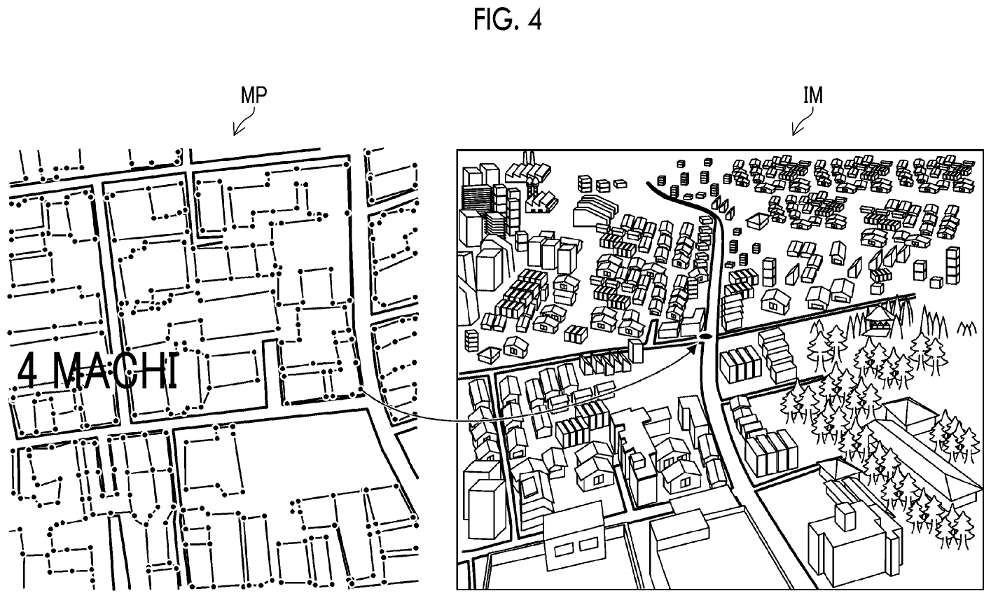

FIG. 4 is a diagram illustrating the aerially captured image IM and the map MP corresponding to the aerially captured image IM.

Black circles on the map MP illustrated in FIG. 4 indicate feature points such as corners of a ground outer periphery of the house and have three-dimensional information such as latitude, longitude, and altitude.

The matching processing unit 202 identifies a position on the aerially captured image IM corresponding to each of a plurality of specific points indicated by the black circles on the map MP, based on the aerially captured image IM and on the map MP.

In the map MP, each house is assigned a house identification (ID) as identification information for identifying each house. The three-dimensional information of the plurality of specific points on the ground outer periphery of the house is recorded in association with the house ID.

### <Principle of Matching Processing>

In order to identify a corresponding position on the aerially captured image IM corresponding to a specific point on the map MP, it is required to obtain a correspondence between three-dimensional space coordinates of a world coordinate system (map coordinate system) and two-dimensional image coordinates of a local coordinate system (camera coordinate system).

### <<Camera Matrix>>

An issue of obtaining the correspondence between the three-dimensional space coordinates and the two-dimensional image coordinates may be addressed by obtaining a camera matrix as a transformation matrix of perspective projection transformation from the following expression based on a camera model.

Image coordinates (u,v)=camera matrix*three-dimensional coordinates (x,y,z)

The camera matrix can be represented by a product of an intrinsic parameter matrix and an extrinsic parameter matrix. The extrinsic parameter matrix is a matrix of transformation from three-dimensional coordinates (world coordinates) to camera coordinates. The extrinsic parameter matrix is a matrix determined by the position and the posture of the camera at the time of aerial imaging and includes a translation parameter and a rotation parameter.

The intrinsic parameter matrix is a matrix of transformation from the camera coordinates to the image coordinates and is a matrix determined by specifications of the camera 14 such as a focal length of the camera and a sensor size and aberration (distortion) of the image sensor.

The three-dimensional coordinates (x, y, z) can be associated with (transformed to) the image coordinates (u, v) by performing transformation from the three-dimensional coordinates (x, y, z) to the camera coordinates using the extrinsic parameter matrix and performing transformation from the camera coordinates to the image coordinates (u, v) using the intrinsic parameter matrix.

The intrinsic parameter matrix can be specified in advance. Meanwhile, the extrinsic parameter matrix depends on the position and the posture of the camera. Thus, it is required to set the extrinsic parameter matrix for each aerially captured image IM.

The camera matrix can be calculated in a case where there are six or more correspondence points between the three-dimensional coordinates on the map MP in a real three-dimensional space and the image coordinates in the aerially captured image IM. In FIG. 4, one feature point on the map MP and a correspondence point on the aerially captured image IM corresponding to the feature point are illustrated by an arrow.

A method of causing a person to designate a plurality of correspondence points or a method of automatically searching for correspondence points which are local image feature amounts using scale-invariant feature transform (SIFT) or the like may be used. The matching processing unit 202 of the present example performs the matching processing by acquiring the camera matrix without searching for the correspondence points.

<<Issue in Case where Sensor Data is Used in Extrinsic Parameter Matrix>>

It is considered to calculate the extrinsic parameter matrix using sensor data (sensor values) obtained from various sensors such as the GPS receiver, the atmospheric pressure sensor, the azimuth sensor, and the gyro sensor mounted on the drone 12, as the information indicating the position and the posture of the camera 14. However, in the camera matrix actually obtained using the sensor data, an issue arises in that a three-dimensional position of the house or the like on the map MP cannot be correctly matched (registered) to the corresponding house or the like on the aerially captured image IM because of an effect of an error in the sensor data.

The matching processing unit 202 of the present example automatically searches for parameter values of the camera matrix based on the sensor data at the time of aerial imaging and obtains optimal parameter values, that is, the camera matrix that can associate (register) a three-dimensional position on the map MP with a position on the aerially captured image IM with high accuracy.

In processing of searching for the parameter values of the camera matrix, the matching processing unit 202 assigns parameter values with reference to the values of the sensor data, transforms the map MP to the image coordinates using a camera matrix of the parameter values, evaluates a ratio of match between a transformation result and the position on the aerially captured image IM, selects parameter values that result in the highest evaluation result, and determines the camera matrix.

In processing of evaluating the ratio of match, the matching processing unit 202 extracts line segments of the outer periphery of the house, a road, or the like from each of the transformation result obtained by transforming the map MP to the image coordinates and the aerially captured image IM, and calculates an evaluation value indicating quantitative evaluation of the ratio of match between the line segments. One line segment is specified by coordinates of two points (a starting point and an end point). Here, the “ratio of match” may be a degree of match including an allowable range with respect to at least one of, preferably a plurality of, a distance between the line segments, a difference between lengths of the line segments, or a difference between inclination angles of the line segments.

The matching processing unit 202 generates a map MP1 registered with the aerially captured image IM by performing perspective projection transformation of the three-dimensional information of the map MP to the aerially captured image IM using a camera matrix Mc determined by automatically searching for the parameter values using line segment matching.

### <<Description of Perspective Projection Transformation Using Camera Matrix>>

Here, a calculation method of transforming the three-dimensional coordinates (x, y, z) of a specific point of the ground outer periphery of the house or the like included in the map MP to coordinates projected to the image sensor of the camera 14, that is, the image coordinates (u, v), will be described in detail.

In the specific point (x, y, z) of the ground outer periphery of the house or the like, x and y are obtained by transforming the latitude and the longitude to UTM coordinates in an orthogonal coordinate system, and z denotes the altitude. In a case where there is height information about a building such as the house, it is desirable to calculate a position of a roof on the image using the height information. In addition, for a house not having the height information, the altitude of the roof may be calculated by assuming, for example, a height of 6 m.

A three-dimensional position of the camera 14 at the time of aerial imaging is denoted by (xc, yc, zc). Here, xc and yc are obtained by transforming the latitude and the longitude of the camera 14 to UTM coordinates, and zc denotes the altitude.

In addition, the posture (imaging direction) of the camera 14 at the time of aerial imaging is specified by an azimuthal angle θh, a tilt angle θt, and a roll angle θr. The azimuthal angle θh is an angle from north with reference to north. The tilt angle θt is a camera angle (depression angle) toward the ground. The roll angle θr is an inclination from the horizontal.

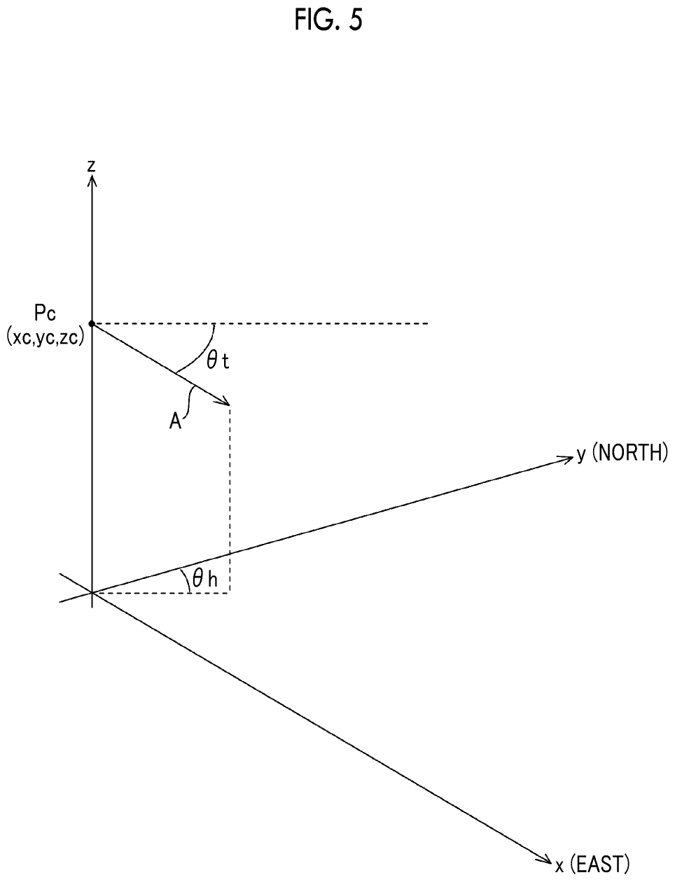

FIG. 5 is a diagram used for describing the position and the posture of the camera.

In a UTM coordinate system, an x axis is defined as east, and a y axis is defined as north. In FIG. 5, the position of the camera 14 is denoted by Pc(xc, yc, zc). Arrow A indicates the imaging direction specified by the posture of the camera 14.

An expression for transforming coordinates of the feature point (x, y, z) of the ground outer periphery of the house or the like to an origin of a projection center (that is, a camera position at the time of imaging) is represented by [Expression 1] below.

$$( \begin{matrix}{x}^{′} \\ {y}^{′} \\ {z}^{′}\end{matrix} ) = ( \begin{matrix}x - xc \\ y - y c \\ z - z c\end{matrix} ) \qquad [ Expression 1 ]$$

In addition, rotation matrices Mh, Mt, and Mr are defined by [Expression 2], [Expression 3], and [Expression 4] below.

$$Mh = ( \begin{matrix}cos ( θ h ) & - sin ( θ h ) & 0 \\ 0 & 0 & 1 \\ sin ( θ h ) & cos ( θ t ) & 0\end{matrix} ) \qquad [ Expression 2 ]$$

$$Mt = ( \begin{matrix}1 & 0 & 0 \\ 0 & cos ( θ t ) & - sin ( θ t ) \\ 0 & sin ( θ t ) & cos ( θ t )\end{matrix} ) \qquad [ Expression 3 ]$$

$$Mr = ( \begin{matrix}cos ( θ r ) & - sin ( θ r ) & 0 \\ sin ( θ r ) & cos ( θ r ) & 0 \\ 0 & 0 & 1\end{matrix} ) \qquad [ Expression 4 ]$$

The coordinates of the feature point of the ground outer periphery of the house or the like of which the origin is the projection center is transformed with the camera coordinates using the following expression.

$$( \begin{matrix}X \\ Y \\ Z\end{matrix} ) = Mr * Mt * Mh ( \begin{matrix}{x}^{′} \\ {y}^{′} \\ {z}^{′}\end{matrix} ) \qquad [ Expression 5 ]$$

The origin of the camera coordinates is the projection center. An X axis denotes a lateral direction of the image sensor. A Y axis denotes a longitudinal direction of the image sensor. A Z axis denotes a depth direction.

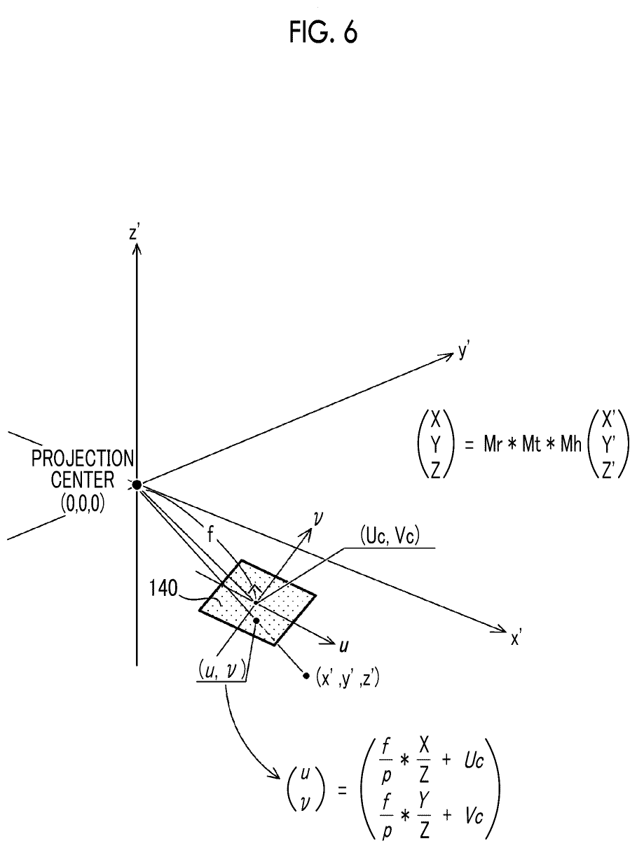

FIG. 6 is a diagram illustratively illustrating a relationship between a three-dimensional space coordinate system having three axes corresponding to three-dimensional coordinates (x′, y′, z′) based on the coordinate transformation in [Expression 1] and an image coordinate system of an image sensor 140 of the camera 14.

The feature point (in meter units) of the camera coordinates obtained using [Expression 5] above is transformed to coordinates (in pixel units) on the aerially captured image IM using the following expression.

$$( \begin{matrix}u \\ v\end{matrix} ) = ( \begin{matrix}\frac{f}{p} * \frac{X}{Z} + U c \\ \frac{f}{p} * \frac{Y}{Z} + V c\end{matrix} ) \qquad [ Expression 6 ]$$

In [Expression 6], f denotes a focal length, and p denotes a pixel pitch. The pixel pitch p is a distance between pixels of the image sensor 140 and is normally common in the longitudinal direction and in the lateral direction. Uc and Vc denote image center coordinates (in pixel units).

### <<Example of Search for Optimal Parameter Values>>

Specific examples of procedures of a calculation method of the camera matrix Mc will be described.

[Procedure 1] The matching processing unit 202 acquires the position and the posture of the camera 14 at the time of imaging from the sensor data. The position (xc_0, yc_0, zc_0) and the posture (θh_0, θt_0, θr_0) acquired from the sensor data are used as reference values in searching for the parameter values.

[Procedure 2] The matching processing unit 202 sets a search range and a step size at a time of searching for each of the parameter values of the position and the posture of the camera 14. For example, the matching processing unit 202 determines the search range to be a range of ±10 m from the reference value and determines the step size to be 1 m for an x coordinate of the position of the camera 14. That is, the search range of the x coordinate of the position of the camera 14 is set to “xc_0−10<xc<xc_0+10”, and the step size at the time of imaging is set to 1 (in meter units). Here, xc−10 that indicates a lower limit of the search range is an example of a search lower limit value, and xc+10 that indicates an upper limit of the search range is an example of a search upper limit value.

The search range and the step size are also set for each of the parameters of a y coordinate and a z coordinate of the position and the posture (θh, θt, θr) of the camera 14. For example, for the azimuth angle θh, a range of +450 with respect to the reference value indicated by the sensor data is set as the search range, and a step size of 1° is set to change the parameter value. Different search ranges and step sizes may be set for each parameter.

[Procedure 3] The matching processing unit 202 determines a combination of the parameter values by moving the step size in the search range for each of the parameters of the position and the posture of the camera 14. Positions (latitude, longitude, and altitude) of the house and the road included in the map MP are transformed to coordinates on the two-dimensional aerially captured image IM using the determined combination of the parameter values (xc, yc, zc) and (θh, θt, θr).

[Procedure 4] The matching processing unit 202 evaluates matching between the map MP1 and the aerially captured image IM using the above line segment matching.

[Procedure 5] The matching processing unit 202, through Procedure 3 and Procedure 4, changes the parameter values of the three-dimensional position and the imaging direction of the camera 14 using all step sizes in the search range of each parameter and employs the parameter values of the position and the posture of the camera 14 having the most favorable evaluation result of the evaluation value of the line segment matching as a correct position and a correct posture of the camera 14. The optimal camera matrix is automatically calculated for each aerially captured image IM, and the map MP1 after transformation that is accurately registered with each aerially captured image IM is obtained.

### <<Summary of Automatic Registration by Line Segment Matching>>

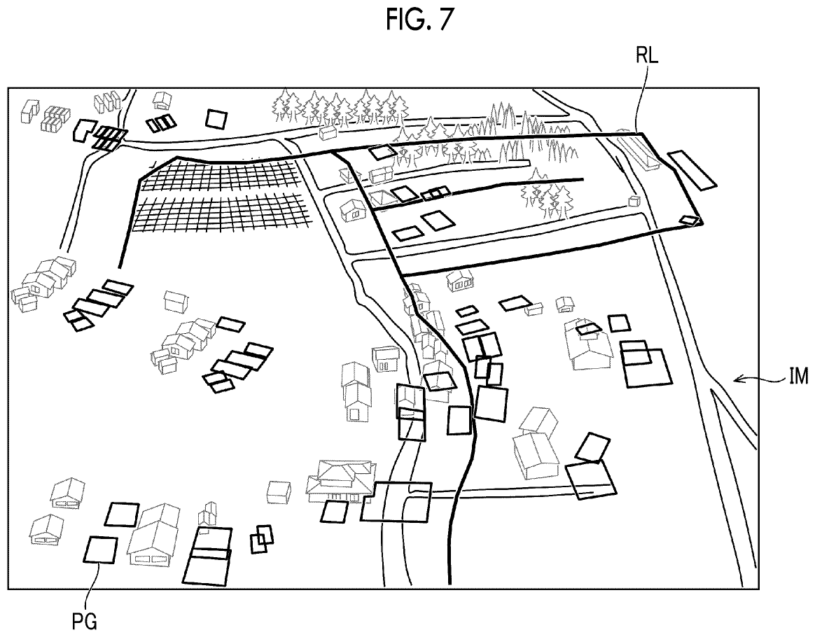

FIG. 7 is a diagram illustrating an example of a composite image in which the positions of the house and the road are superimposed on the aerially captured image IM by transforming the map to the image coordinates using the camera matrix in which the sensor data is used as the parameter values.

In FIG. 7, each of a plurality of polygonal shapes PG superimposed on the aerially captured image IM indicates the outer periphery of the house of the map transformed using the camera matrix in which the sensor data is used as the parameter values. In addition, a line RL superimposed on the aerially captured image IM indicates the road of the map transformed using the same camera matrix.

As illustrated in FIG. 7, the polygonal shapes PG and the lines RL significantly deviate from the positions of the house and the road in the aerially captured image IM. This is caused by an error or the like in the camera matrix using the sensor data (sensor values) as the parameters of the position and the posture of the camera 14, and the house and the like on the map cannot be correctly matched to the house and the like on the aerially captured image IM.

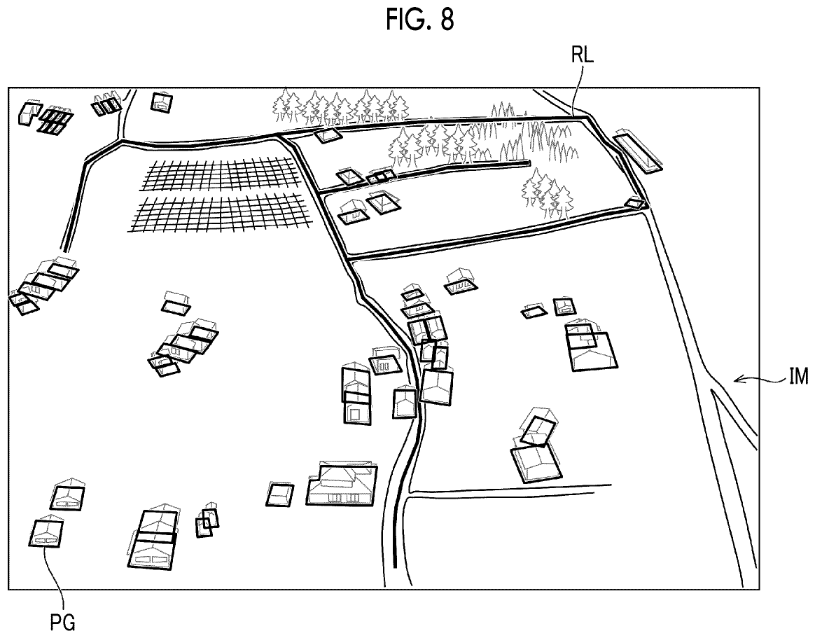

FIG. 8 is a diagram illustrating an example of a composite image in which the positions of the house and the road are superimposed on the aerially captured image IM by automatically calculating the optimal camera matrix using the matching processing unit and transforming the map MP to the image coordinates using the optimal camera matrix.

The matching processing unit 202 of the present example can accurately obtain the camera matrix Mc as described above, and can correctly match the map (map illustrated by a bold line) to the aerially captured image IM as illustrated in FIG. 8 by performing the perspective projection transformation of the three-dimensional information of the map MP to the aerially captured image IM using the camera matrix Mc.

By correctly matching the map MP to the aerially captured image IM, the house ID of the map MP can be associated with the house on the aerially captured image IM, and the attribute information of the house (an address of the house, the number of years since building, a type of the house, and the like) can be acquired from the house ID associated with each house on the aerially captured image IM.

In FIG. 3, the external shape information acquisition unit 203 of the house acquires two-dimensional external shape information of the house on the aerially captured image IM from the result of the matching processing (for example, the camera matrix Mc) performed by the matching processing unit 202 and from the region information of the house included in the map MP.

Here, the region information of the house is three-dimensional information indicating a three-dimensional region of the house in the real space.

The processing of matching the map MP to the aerially captured image IM via the matching processing unit 202 is not limited to automatic registration using the above line segment matching. The map MP may be matched to the aerially captured image IM based on well-known correspondence point detection. For example, the map MP can be matched to the aerially captured image IM by performing the correspondence point detection between a plurality of feature points as landmarks of the aerially captured image IM and corresponding feature points of the landmarks on the map MP, determining parameters of geometric transformation (projective transformation, affine transformation, or the like) such that each correspondence point matches, and geometrically transforming the map MP.

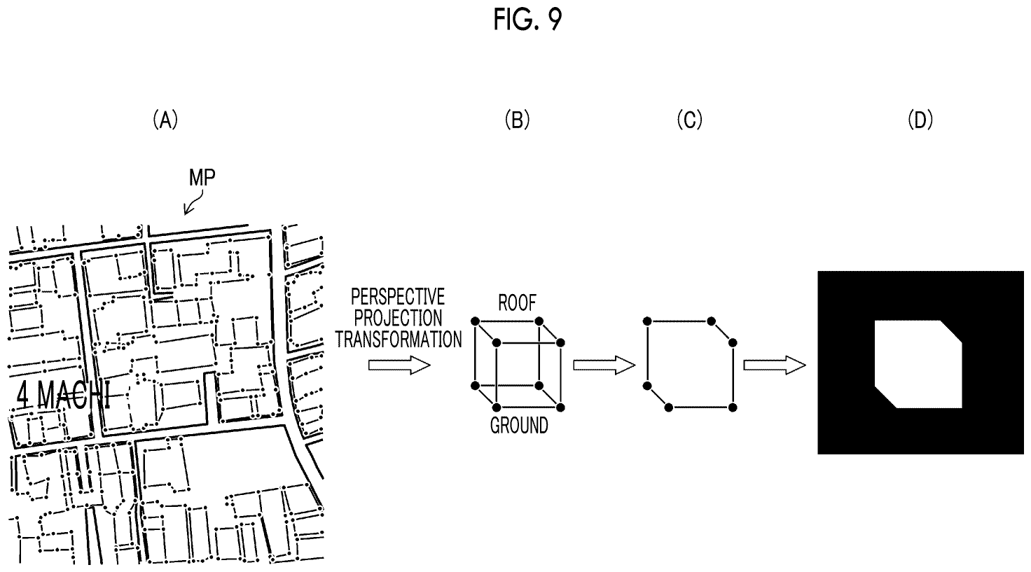

FIG. 9 is a diagram illustrating a flow in which the external shape information acquisition unit of the house acquires the external shape information of the house.

In the present example, as described above, the map MP is correctly matched to the aerially captured image IM by performing the perspective projection transformation of the map MP having the three-dimensional information using the camera matrix Mc.

A case of correctly matching the region information (three-dimensional external shape information) of one house on the map MP illustrated in (A) of FIG. 9 onto the aerially captured image IM will be described.

An example of the three-dimensional region information of the house is illustrated in the following table.

TABLE 1
House ID: xxxxxxxx, building height (height) = 6.0 m

| | Latitude | Longitude | Altitude |
|---|---|---|---|
| 1 | 32.2404778 | 130.6934385 | 0.5 |
| 2 | 32.2404536 | 130.6934767 | 1.0 |
| 3 | 32.2403944 | 130.6934244 | 0.9 |
| 4 | 32.2404186 | 130.6933862 | 0.5 |

As illustrated in [Table 1], the three-dimensional region information of the house has three-dimensional positions (latitude, longitude, and altitude) of four points of the ground outer periphery of the house and information about a uniform building height. The region information of the house in the present example has three-dimensional information of vertices of a polygonal prism (rectangular cuboid).

The three-dimensional information of the house represented by the rectangular cuboid can be correctly matched onto the aerially captured image IM by performing the perspective projection transformation using the camera matrix Mc ((B) of FIG. 9). Four points on a ground side of a polygon illustrated in (B) of FIG. 9 are projected positions of the four points of the ground outer periphery illustrated in [Table 1], and four points on a roof side are projected positions of four points at the uniform building height (=6.0 m) with respect to the four points on the ground side.

Next, outer periphery information of the house on the map MP after the matching processing is extracted ((C) of FIG. 9). The outer periphery information of the house is the external shape information of the house obtained by connecting six points on the outermost periphery among eight points illustrated in (B) of FIG. 9.

The external shape information acquisition unit 203 generates a mask image by coloring an inside of the extracted outer periphery information (external shape information) of the house white (transparent) and coloring an outside of the extracted outer periphery information black (opaque) ((D) of FIG. 9). The mask image is an image used for extracting (cutting out) the house image from the aerially captured image IM.

For each house captured in the aerially captured image IM, the external shape information acquisition unit 203 acquires the external shape information of the house and generates the mask image for cutting out. The external shape information may be generated as a slightly larger region such that the region does not significantly overlap with an adjacent house.

The aerially captured image IM is input into the house image extraction unit 204 illustrated in FIG. 3. The house image extraction unit 204 extracts (cuts out) a house image H from the aerially captured image IM based on the external shape information (the mask image corresponding to the external shape information) of the house acquired by the external shape information acquisition unit 203.

While the house image extraction unit 204 extracts the house image H showing each house captured in the aerially captured image IM, the house image extraction unit 204, for example, can extract an image of a region corresponding to the house before the occurrence of the disaster even in a case where the house is destructed or submerged by the disaster.

The house image H extracted by the house image extraction unit 204 is output to the classification processing unit 205 of the status of the house and the association processing unit 206.

The classification processing unit 205 performs the classification processing of recognizing the status of the house after the occurrence of the disaster based on the house image H and classifying the house as any of the plurality of classes (first classes) using the recognition result. The classification processing unit 205 can classify the class of the status (disaster status) of the house using a disaster determination artificial intelligence (AI) into which the house image is input.

The memory 210 (FIG. 2) stores a disaster determination AI model (learning model) that outputs a classification result indicating the first class in a case where the house image H is input. By using the learning model stored in the memory 210, the classification processing unit 205 inputs the house image H into the learning model and acquires the classification result estimated by the learning model.

The classification processing unit 205, for example, has three classes of intactness, partial collapse, and complete collapse as the plurality of first classes, classifies the house as any class of the three classes of intactness, partial collapse, and complete collapse based on the input house image, and outputs the classification result to the association processing unit 206.

The association processing unit 206 performs processing of associating the classification result (any class of the plurality of first classes) classified by the classification processing unit 205 with the house (house image) on the aerially captured image IM.

Since the house on the aerially captured image IM can be associated with the house on the map MP by the matching processing, the association processing unit 206 can acquire the house ID corresponding to the house image H and associate information (map information and the attribute information) about the house managed by the database 220 with the classification result based on the house ID.

The combining processing unit 207 performs combining processing of combining (superimposing) the classification result (the first information indicating the first class) of the house associated for each house image H with the aerially captured image IM. The first information of the present example is information indicating a frame line that surrounds the house on the aerially captured image IM and that has different colors of the frame line depending on the class of the classification performed by the classification processing unit 205. For example, a green frame, a yellow frame, and a red frame are assigned to an intact house, a partially collapsed house, and a completely collapsed house, respectively, as the first information. In addition, the combining processing unit 207 can obtain a position and a size of the frame line combined to surround the house, based on the external shape information acquired by the external shape information acquisition unit 203.

An aerially captured image IMs combined with the first information indicating the classification result of the house by the combining processing unit 207 is output to the display device 230 (FIGS. 1 and 2) and is displayed on the display device 230.

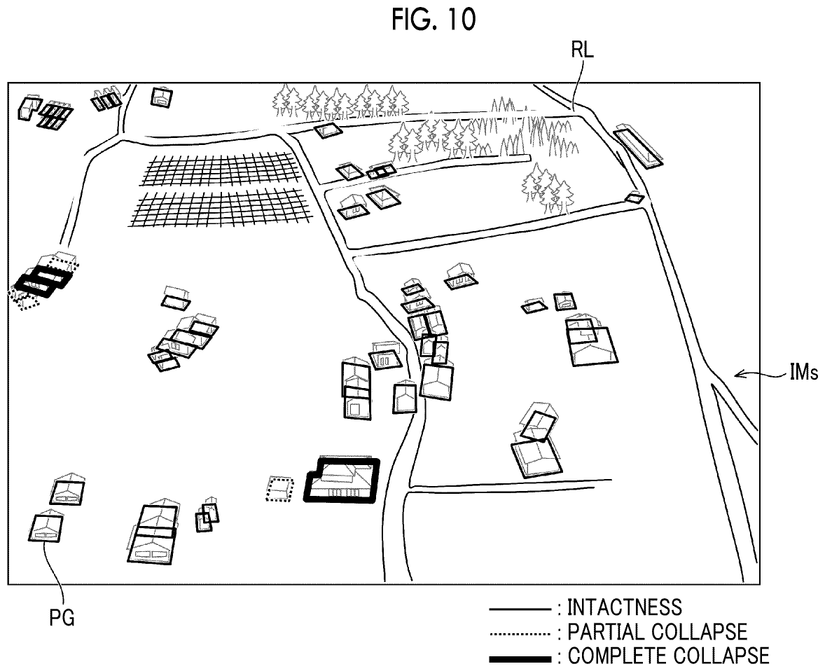

FIG. 10 is a diagram illustrating an example of the aerially captured image combined with the first information indicating the classification result of the house.

The aerially captured image IMs illustrated in FIG. 10 is combined with three types of frame lines as the frame line surrounding the house. In FIG. 10, a frame line of a thin solid line indicates intactness, a frame line of a dotted line indicates partial collapse, and a frame line of a bold solid line indicates complete collapse. While the three types of frame lines indicating intactness, partial collapse, and complete collapse are distinguished by a line type in FIG. 10, visibility of the classification result can be further improved by distinguishing the frame lines by color such as the green frame, the yellow frame, and the red frame.

In addition, while the classification result of each house is displayed using the color or the like of the frame line surrounding the house in the present example, the present invention is not limited to this example. A text indicating intactness, partial collapse, or complete collapse may be combined as the first information, and furthermore, different colors of green, yellow, and red may be set as a color of the text depending on intactness, partial collapse, and complete collapse.

Furthermore, the first information indicating the classification result may not be displayed for the intact house in order to avoid cumbersome display of the first information indicating the classification result. In addition, in a case where a desired class is selected using the operating unit 250 so that a user can check only the house classified as the desired class (for example, complete collapse), the processor 200 may superimpose only the first information corresponding to the selected class on the aerially captured image IM.

By using the house status provision apparatus 20 of the present embodiment, an office or the like of disaster response headquarters of the local government can quickly perceive the disaster status of the house in the disaster region and quickly establish a plan for disaster rescue activity.

In addition, the officer of the local government, the officer of the fire station, or the like carrying the terminal apparatus 24 can check the aerially captured image IMs on which the classification result of the disaster status of the house is displayed in a superimposed manner, using the terminal apparatus 24.

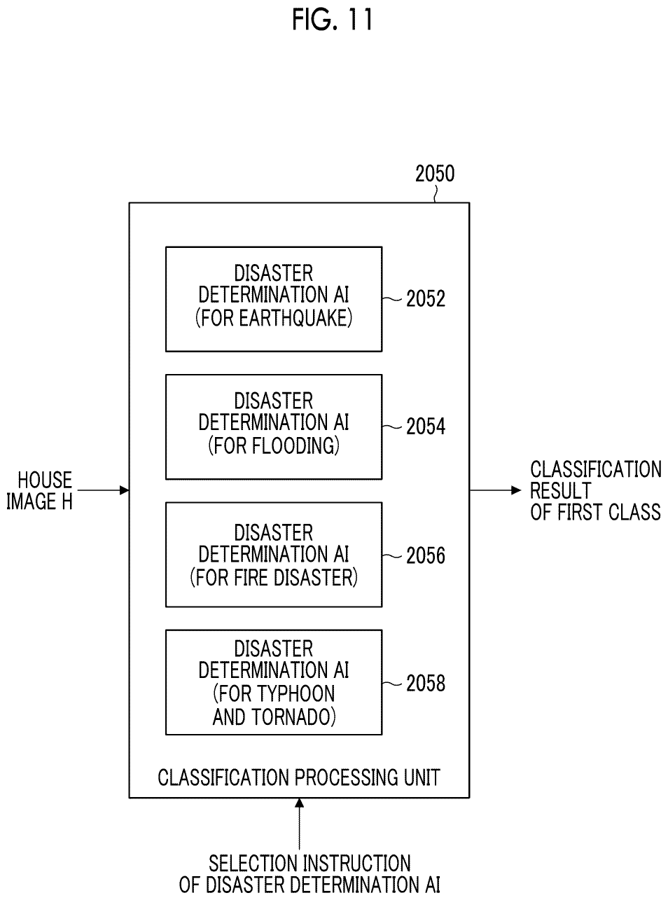

FIG. 11 is a block diagram illustrating another embodiment of the classification processing unit.

A classification processing unit 2050 illustrated in FIG. 11 is another embodiment of the classification processing unit 205 of the status of the house illustrated in FIG. 3 and acquires the classification result obtained by classifying the status of the house using any of four disaster determination AIs (learning models) 2052, 2054, 2056, and 2058.

The four disaster determination AIs 2052, 2054, 2056, and 2058 are learning models corresponding to types of disasters. The disaster determination AI 2052 is a determination AI for earthquake that determines the status of the house subjected to an earthquake disaster. The disaster determination AI 2054 is a determination AI for flooding that determines the status of the house subjected to a flooding disaster. The disaster determination AI 2056 is a disaster determination AI for fire disaster that determines the status of the house subjected to a fire disaster. The disaster determination AI 2058 is a determination AI for typhoon and tornado that determines the status of the house subjected to a typhoon disaster or a tornado disaster.

The disaster status of the house varies depending on the type of the disaster. Thus, it is preferable to select the disaster determination AI (learning model) to be used in accordance with the type of the disaster that has currently occurred.

The classification processing unit 2050 selects the disaster determination AI corresponding to the type of the disaster from a plurality of (four) disaster determination AIs 2052, 2054, 2056, and 2058 and acquires the classification result using the selected disaster determination AI.

The selection of the disaster determination AI is considered to be performed using a method of performing the selection by receiving a selection instruction of the disaster determination AI provided by a user operation from the operating unit 250, or a method of automatically performing the selection by inputting the aerially captured image into an AI that determines the type of the disaster to estimate the type of the disaster.

The disaster determination AI is not limited to the types corresponding to the above four types of disasters. In addition, the class of the disaster status of the house may be classified using two or more types of disaster determination AIs together.

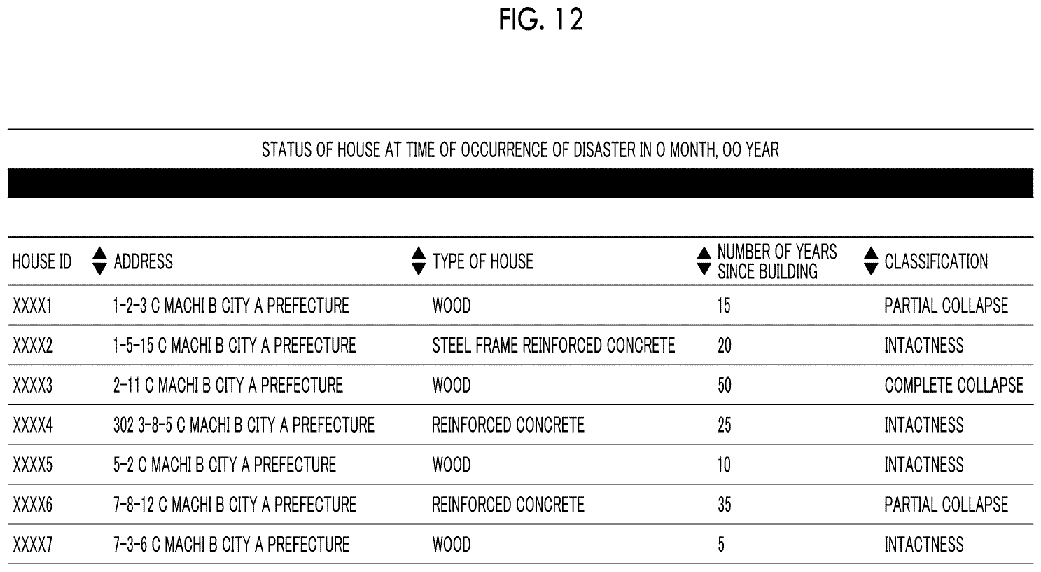

FIG. 12 is a table illustrating a list of the attribute information related to the house.

For example, attribute information managed in a register (the memory 210, the database 220, or the like) owned by the local government can be used as the attribute information related to the house.

In the example illustrated in FIG. 12, the address, the type of the house, the number of years since building of the house, the disaster status (classification result) of the house, and the like are managed in association with the house ID.

The type of the house is a type of building structure such as wood, steel frame reinforced concrete, or reinforced concrete. In addition, in a field of classification, the classification result obtained by classifying the class of the disaster status of the house at the time of occurrence of the current disaster is registered in association with the house (house ID).

As described above, by correctly matching the map MP to the aerially captured image IM, the house (house ID) on the map MP can be associated with the house on the aerially captured image IM. Thus, the house on the aerially captured image IM can be associated with the attribute information registered in association with the house ID.

The house status provision apparatus 20 can classify the number of years since building of the house or the type of the house as any of a plurality of classes (second classes) based on the attribute information of the house (the number of years since building of the house or the type of the house), associate the house on the aerially captured image with the classified second class, superimpose second information indicating the second class on the aerially captured image IM, and display the aerially captured image IM on the display device 230 or the like.

In a case where the second information indicating the second class indicating the number of years since building of the house or the type of the house is displayed in a superimposed manner on the house on the aerially captured image IM, the house status provision apparatus 20 can receive a switching instruction of the information to be displayed and display the second information in a superimposed manner instead of the first information indicating the classification result of the disaster status of the house.

For example, the plurality of second classes as the number of years since building of the house can be four classes of less than 10 years, 10 years to 30 years, 30 years to 50 years, and 50 years or more, and the second information indicating the second class displayed in a superimposed manner on the aerially captured image IM can be a color frame having different colors depending on the four classes. In addition, for example, the plurality of second classes as the type of the house can be four classes of wood, reinforced concrete, steel frame reinforced concrete, and other structures, and the second information indicating the second class displayed in a superimposed manner on the aerially captured image IM can be a color frame having different colors depending on the four classes.

By displaying the second class indicating the number of years since building of the house or the type of the house, what kind of house is resistant to the disaster can be easily perceived.

### [Embodiment of House Status Provision Method]

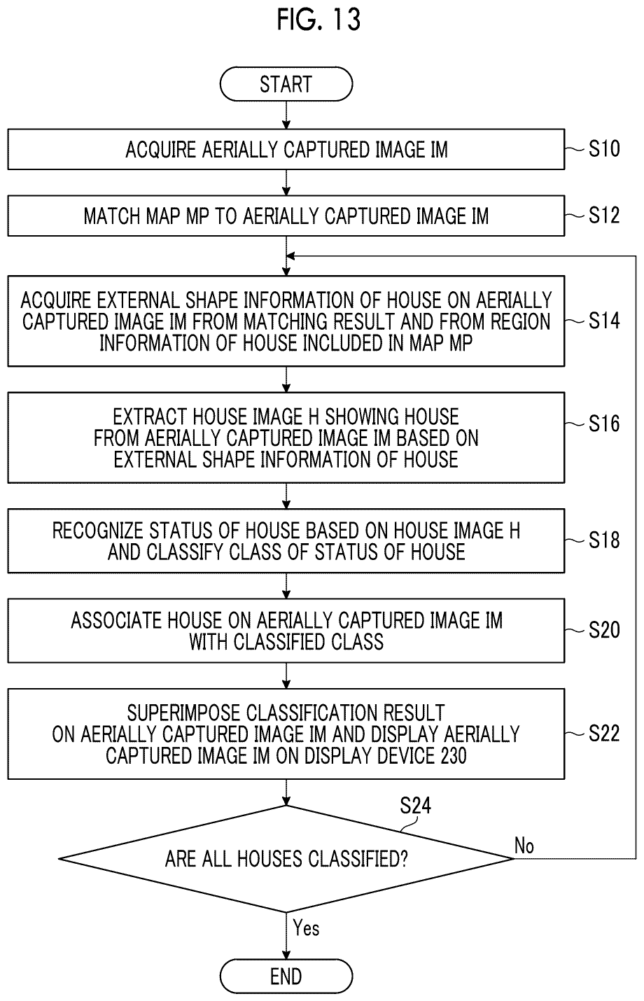

FIG. 13 is a flowchart illustrating an embodiment of the house status provision method according to the embodiment of the present invention.

The house status provision method illustrated in FIG. 13 is a method performed by the house status provision apparatus of the embodiment illustrated in FIG. 3.

In FIG. 13, the processor 200 acquires the aerially captured image IM of the disaster region captured by the camera 14 mounted on the drone 12 (step S10).

Next, the processor 200 matches the aerially captured image IM to the map MP (step S12). The map MP has the three-dimensional information of the aerially captured disaster region and is read out from the database 220. In the present example, the map MP1 matched to the aerially captured image IM is generated by searching for the position and the posture of the camera 14 at the time of capturing the aerially captured image IM with high accuracy and performing the perspective projection transformation of the three-dimensional information of the map MP to the aerially captured image IM using the camera matrix Mc determined by the search.

Next, the processor 200 acquires an external shape of the house on the aerially captured image IM from a matching result and from the region information of the house included in the map MP (step S14). The region information of the house is three-dimensional information indicating the three-dimensional region of the house in the real space. In the present example, the region information of the house includes three-dimensional positions (latitude, longitude, and altitude) of a plurality of points of the ground periphery of the house and the information about the uniform building height. The external shape of the house on the aerially captured image IM is acquired by performing the perspective projection transformation of the region information (three-dimensional information) of the house using the camera matrix Mc to match the region information of the house to the house on the aerially captured image IM.

The processor 200 extracts (cuts out) the house image H showing the house from the aerially captured image IM based on the external shape of the house (step S16).

The processor 200 recognizes the status of the house based on the cut house image H and classifies the class of the house as any class of the plurality of first classes using the recognition result (step S18). The processor 200, by using the disaster determination AI (learning model), acquires the classification result estimated by the learning model by inputting the house image H into the learning model. For example, the plurality of first classes include three classes of intactness, partial collapse, and complete collapse, and the disaster determination AI outputs any class of the three classes of intactness, partial collapse, and complete collapse as the classification result of the status (disaster status) of the house.

Next, the processor 200 associates the house on the aerially captured image IM with the classified class (any class of the plurality of first classes) (step S20). Since the map MP is registered with the aerially captured image IM, information (house ID) about the house on the map MP corresponding to the house image H can be acquired, and the information (the map information and the attribute information) about the house managed by the database 220 can be associated with the classification result based on the house ID.

The processor 200 superimposes information (first information) indicating the classification result of the house on the aerially captured image IM and displays the aerially captured image IM on the display device 230 (step S22). The first information is information indicating a frame line that surrounds the house on the aerially captured image IM and that has different colors of the frame line depending on the class of the classification. For example, a green frame is assigned to an intact house, a yellow frame is assigned to a partially collapsed house, and a red frame is assigned to a completely collapsed house.

Next, the processor 200 determines whether or not the classification of the classes of all houses captured in the aerially captured image IM is finished (step S24). In a case where it is determined that the classification of the classes of all houses is not finished (in a case of “No”), the processor 200 transitions to step S14. Accordingly, the external shape information of other houses on the aerially captured image IM is acquired, and the processing of step S16 to step S24 is repeated.

Meanwhile, in a case where it is determined that the classification of the classes of all houses is finished (in a case of “Yes”), the processor 200 finishes the present processing and can display the aerially captured image IMs on which the color frame indicating the disaster status of the house is superimposed, on the display device 230 for all houses on the aerially captured image IM.

By using the aerially captured image IMs, the disaster status of the house in the disaster region can be quickly perceived, and a plan for disaster rescue activity can be quickly established.

### [Other]

In the present embodiment, for example, a hardware structure of a processing unit such as a central processing unit (CPU) executing various types of processing includes the following various processors. The various processors include a CPU that is a general-purpose processor functioning as various processing units by executing software (program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs or a combination of a CPU and an FPGA). In addition, a plurality of processing units may be composed of one processor. As an example of a plurality of processing units composed of one processor, first, as represented by a computer such as a client and a server, a form in which one processor is composed of a combination of one or more CPUs and software and the processor functions as a plurality of processing units is possible. Second, as represented by a system on chip (SoC) and the like, a form of using a processor that implements functions of the entire system including a plurality processing units in one integrated circuit (IC) chip is possible. Accordingly, various processing units are configured using one or more of the various processors as a hardware structure.

In addition, the hardware structure of the various processors is more specifically an electric circuit (circuitry) in which circuit elements such as semiconductor elements are combined.

Furthermore, the present invention is not limited to the above embodiment, and various modifications, of course, can be made without departing from the spirit of the present invention.

### EXPLANATION OF REFERENCES

12: drone
13: gimbal head
14: camera
16: remote controller
20: house status provision apparatus
22: network
24: terminal apparatus
200: processor
201: image acquisition unit
202: matching processing unit
203: external shape information acquisition unit
204: house image extraction unit
205, 2050: classification processing unit
206: association processing unit
207: combining processing unit
210: memory
220: database
230: display device
240: input-output interface
250: operating unit
2052, 2054, 2056, 2058: disaster determination AI
S10 to S24: step

What is claimed is:

1. A house status provision apparatus comprising:
a processor,
wherein the processor is configured to perform:
processing of acquiring an aerially captured image in which a target region in which a plurality of houses are present is imaged;
matching processing of matching a map stored in a memory to the aerially captured image based on the aerially captured image and on the map;
processing of acquiring external shape information of the house on the aerially captured image from a result of the matching processing and from region information of the house included in the map;
processing of extracting a house image showing the house from the aerially captured image based on the acquired external shape information of the house;
classification processing of recognizing status of each of the plurality of houses based on the extracted house image and classifying the house as any of a plurality of first classes using a recognition result; and
processing of associating the house on the aerially captured image with the classified first class.

2. The house status provision apparatus according to claim 1,
wherein the memory stores three-dimensional region information of the house included in the map, and
the processor is configured to:
estimate a position and a posture of a camera that captures the aerially captured image, using the matching processing; and
acquire the external shape information of the house on the aerially captured image by performing perspective projection transformation of the three-dimensional region information of the house based on the estimated position and the estimated posture of the camera.

3. The house status provision apparatus according to claim 1,
wherein the processor is configured to superimpose first information indicating the first class associated with the house on the aerially captured image, on the aerially captured image and display the aerially captured image on a display device.

4. The house status provision apparatus according to claim 3,
wherein the first information is information indicating a frame line that surrounds the house and that has different colors of the frame line or different line types of the frame line depending on the classified first class.

5. The house status provision apparatus according to claim 1,
wherein the plurality of first classes are a plurality of first classes including complete collapse and partial collapse corresponding to disaster status of the house caused by a disaster.

6. The house status provision apparatus according to claim 1,
wherein the memory stores a learning model that outputs a classification result indicating the first class in a case where the house image is input, and
in the classification processing of the processor, the learning model stored in the memory is used, and a classification result estimated by the learning model is acquired by inputting the house image into the learning model.

7. The house status provision apparatus according to claim 6,
wherein the learning model stored in the memory includes a plurality of learning models corresponding to types of disasters, and
the processor is configured to select a learning model corresponding to a type of a disaster from the plurality of learning models and acquire the classification result using the selected learning model.

8. The house status provision apparatus according to claim 1,
wherein the memory stores attribute information related to the house included in the map, and
the processor is configured to acquire the attribute information related to the house from the memory and associate the attribute information with the house on the aerially captured image.

9. The house status provision apparatus according to claim 8,
wherein the processor is configured to superimpose first information indicating the first class and the attribute information associated with the house on the aerially captured image, on the aerially captured image and display the aerially captured image on a display device.

10. The house status provision apparatus according to claim 8,
wherein the attribute information related to the house includes the number of years since building of the house or a type of the house, and
the processor is configured to:
classify the number of years since building of the house or the type of the house as any of a plurality of second classes based on the number of years since building of the house or on the type of the house;
associate the house on the aerially captured image with the classified second class; and
superimpose second information indicating the second class on the aerially captured image and display the aerially captured image on a display device.

11. A house status provision method executed by a house status provision apparatus including a processor, the method comprising:
a step of acquiring, via the processor, an aerially captured image in which a target region in which a plurality of houses are present is imaged;
a step of performing, via the processor, matching processing of matching a map stored in a memory to the aerially captured image based on the aerially captured image and on the map;
a step of acquiring, via the processor, external shape information of the house on the aerially captured image from a result of the matching processing and from region information of the house included in the map;
a step of extracting, via the processor, a house image showing the house from the aerially captured image based on the acquired external shape information of the house;
a step of recognizing, via the processor, status of each of the plurality of houses based on the extracted house image and classifying the house as any of a plurality of first classes using a recognition result; and
a step of associating, via the processor, the house on the aerially captured image with the classified first class.

12. The house status provision method according to claim 11,
wherein the memory stores three-dimensional region information of the house included in the map, and
the processor is configured to:
estimate a position and a posture of a camera that captures the aerially captured image, using the matching processing; and
acquire the external shape information of the house on the aerially captured image by performing perspective projection transformation of the three-dimensional region information of the house based on the estimated position and the estimated posture of the camera.

13. The house status provision method according to claim 11,
wherein the processor is configured to superimpose first information indicating the first class associated with the house on the aerially captured image, on the aerially captured image and display the aerially captured image on a display device.

14. The house status provision method according to claim 13,
wherein the first information is information indicating a frame line that surrounds the house and that has different colors of the frame line or different line types of the frame line depending on the classified first class.

15. The house status provision method according to claim 11,
wherein the plurality of first classes are a plurality of first classes including complete collapse and partial collapse corresponding to disaster status of the house caused by a disaster.
